(19) United States
(12) Patent Application Publication
(10) Pub. No.: US 2017/0010859 A1
(43) Pub. Date: Jan. 12, 2017

(54) USER INTERFACE SYSTEM, USER INTERFACE CONTROL DEVICE, USER INTERFACE CONTROL METHOD, AND USER INTERFACE CONTROL PROGRAM

(71) Applicant: MITSUBISHI ELECTRIC CORPORATION, Tokyo (JP)

(72) Inventor: Masato HIRAI, Tokyo (JP)

(73) Assignee: MITSUBISHI ELECTRIC CORPORATION, Tokyo (JP)

(21) Appl. No.: 15/124,303

(22) PCT Filed: Apr. 22, 2014
(86) PCT No.: PCT/JP2014/002263

§ 371 Date: Sep. 7, 2016

(51) Int. Cl. G06F 3/16; G10L 15/22

(52) U.S. Cl. CPC G06F 3/167; G10L 15/22; G06F 3/04842

(57) ABSTRACT

An object of the present invention is to reduce an operational load of a user who performs a voice input. In order to achieve the object, a user interface system according to the present invention includes: an estimation section 3 that estimates an intention of a voice operation of the user, based on information related to a current situation; a candidate selection section 5 that allows the user to select one candidate from among a plurality of candidates for the voice operation estimated by the estimation section 3; a guidance output section 7 that outputs a guidance to request the voice input of the user concerning the candidate selected by the user; and a function execution section 10 that executes a function corresponding to the voice input of the user to the guidance.

### TECHNICAL FIELD

The present invention relates to a user interface system and a user interface control device capable of a voice operation.

### BACKGROUND ART

In a device having a user interface capable of a voice operation, one button for the voice operation is usually prepared. When the button for the voice operation is pressed down, a guidance “please talk when a bleep is heard” is played, and a user utters (voice input). In the case where the user utters, a predetermined utterance keyword is uttered according to predetermined procedures. At the time, the voice guidance is played from the device, and a target function is executed after an interaction with the device is performed several times. Such a device has a problem that the user cannot memorize the utterance keyword or the procedures, which makes it impossible to perform the voice operation. In addition, the device has a problem that it is necessary to perform the interaction with the device a plurality of times, so that it takes time to complete the operation.

Accordingly, there is a user interface in which execution of a target function is allowed with one utterance without memorization of procedures when a plurality of buttons are associated with voice recognitions related to functions of the buttons (Patent Literature 1).

### CITATION LIST

### Patent Literature

Patent Literature 1: WO 2013/015364

### SUMMARY OF THE INVENTION

### Technical Problem

However, there is a limitation that the number of buttons displayed on a screen corresponds to the number of entrances to a voice operation, and hence a problem arises in that many entrances to the voice operation cannot be arranged. In addition, in the case where many entrances to the voice operation are arranged, a problem arises in that the number of buttons becomes extremely large, so that it becomes difficult to find out a target button.

The present invention has been made in order to solve the above problems, and an object thereof is to reduce an operational load of a user who performs a voice input.

### Solution to Problem

A user interface system according to the invention includes: an estimator that estimates an intention of a voice operation of a user, based on information related to a current situation; a candidate selector that allows the user to select one candidate from among a plurality of candidates for the voice operation estimated by the estimator; a guidance output processor that outputs a guidance to request a voice input of the user concerning the candidate selected by the user; and a function executor that executes a function corresponding to the voice input of the user to the guidance.

A user interface control device according to the invention includes: an estimator that estimates an intention of a voice operation of a user, based on information related to a current situation; a guidance generator that generates a guidance to request a voice input of the user concerning one candidate that is determined based on a selection by the user from among a plurality of candidates for the voice operation estimated by the estimator; a voice recognizer that recognizes the voice input of the user to the guidance; and a function determinator that outputs instruction information such that a function corresponding to the recognized voice input is executed.

A user interface control method according to the invention includes the steps of: estimating a voice operation intended by a user, based on information related to a current situation; generating a guidance to request a voice input of the user concerning one candidate that is determined based on a selection by the user from among a plurality of candidates for the voice operation estimated in the estimating step; recognizing the voice input of the user to the guidance; and outputting instruction information such that a function corresponding to the recognized voice input is executed.

A user interface control program according to the invention causes a computer to execute: estimation processing that estimates an intention of a voice operation of a user, based on information related to a current situation; guidance generation processing that generates a guidance to request a voice input of the user concerning one candidate that is determined based on a selection by the user from among a plurality of candidates for the voice operation estimated by the estimation processing; voice recognition processing that recognizes the voice input of the user to the guidance; and processing that outputs instruction information such that a function corresponding to the recognized voice input is executed.

### Advantageous Effects of Invention

According to the present invention, since an entrance to the voice operation that meets the intention of the user is provided in accordance with the situation, it is possible to reduce an operational load of the user who performs the voice input.

### BRIEF DESCRIPTION OF DRAWINGS

FIG. 1 is a view showing a configuration of a user interface system in Embodiment 1;

FIG. 2 is a flowchart showing an operation of the user interface system in Embodiment 1;

FIG. 3 is a display example of a voice operation candidate in Embodiment 1;

FIG. 4 is an operation example of the user interface system in Embodiment 1;

FIG. 5 is a view showing a configuration of a user interface system in Embodiment 2;

FIG. 6 is a flowchart showing an operation of the user interface system in Embodiment 2;

FIG. 7 is an operation example of the user interface system in Embodiment 2;

FIG. 8 is a view showing another configuration of the user interface system in Embodiment 2;

FIG. 9 is a view showing a configuration of a user interface system in Embodiment 3;

FIG. 10 is a view showing an example of keyword knowledge in Embodiment 3;

FIG. 11 is a flowchart showing an operation of the user interface system in Embodiment 3;

FIG. 12 is an operation example of the user interface system in Embodiment 3;

FIG. 13 is a view showing a configuration of a user interface system in Embodiment 4;

FIG. 14 is a flowchart showing an operation of the user interface system in Embodiment 4;

FIG. 15 shows an example of an estimated voice operation candidate and a likelihood thereof in Embodiment 4;

FIG. 16 is a display example of the voice operation candidate in Embodiment 4;

FIG. 17 shows an example of the estimated voice operation candidate and the likelihood thereof in Embodiment 4;

FIG. 18 is a display example of the voice operation candidate in Embodiment 4; and

FIG. 19 is a view showing an example of a hardware configuration of a user interface control device in each of Embodiments 1 to 4.

### DESCRIPTION OF EMBODIMENTS

### Embodiment 1

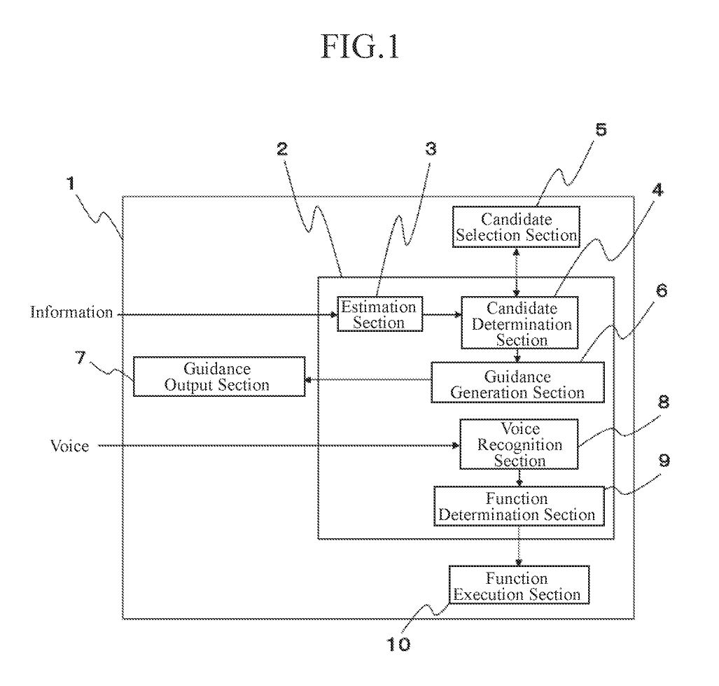

FIG. 1 is a view showing a user interface system in Embodiment 1 of the invention. A user interface system 1 includes a user interface control device 2, a candidate selection section 5, a guidance output section 7, and a function execution section 10. The candidate selection section 5, guidance output section 7, and function execution section 10 are controlled by the user interface control device 2. In addition, the user interface control device 2 has an estimation section 3, a candidate determination section 4, a guidance generation section 6, a voice recognition section 8, and a function determination section 9. Hereinbelow, a description will be made by taking the case where the user interface system is applied to driving of an automobile as an example.

The estimation section 3 receives information related to a current situation, and estimates a candidate for a voice operation that a user will perform at the present time, that is, the candidate for the voice operation that meets the intention of the user. Examples of the information related to the current situation include external environment information and history information. The estimation section 3 may use both of the information sets or may also use either one of them. The external environment information includes vehicle information such as the current speed of an own vehicle and a brake condition, and information such as temperature, current time, and current position. The vehicle information is acquired with a CAN (Controller Area Network) or the like. In addition, the temperature is acquired with a temperature sensor or the like, and the current position is acquired by using a GPS signal to be transmitted from a GPS (Global Positioning System) satellite. The history information includes, for example, in the past, setting information of a facility set as a destination by a user, and equipment such as a car navigation device, an audio, an air conditioner, and a telephone operated by the user, a content selected by the user in the candidate selection section 5 described later, a content input by voice by the user, and a function executed in the function execution section 10 described later, and the history information is stored together with date and time of occurrence and position information and so on in each of the above setting information, contents, function. Consequently, the estimation section 3 uses for the estimation, the information related to the current time and the current position from the history information. Thus, even in the past information, the information that influences the current situation is included in the information related to the current situation. The history information may be stored in a storage section in the user interface control device or may also be stored in a storage section of a server.

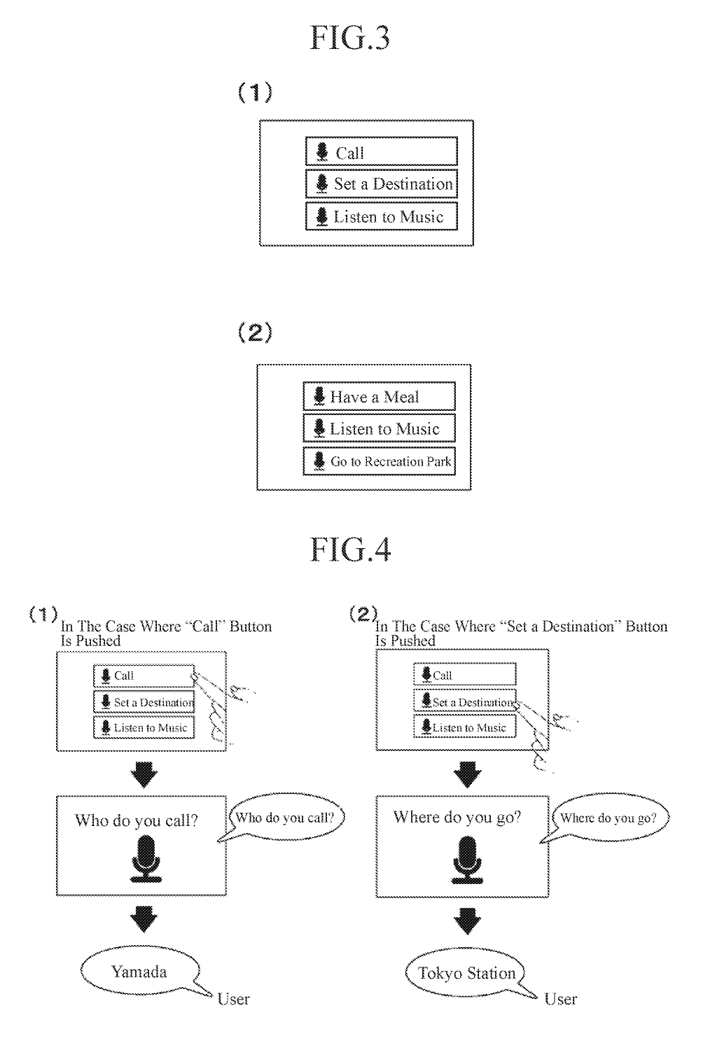

From among a plurality of candidates for the voice operation estimated by the estimation section 3, the candidate determination section 4 extracts some candidates by the number that can be presented by the candidate selection section 5, and outputs the extracted candidates to the candidate selection section 5. Note that the estimation section 3 may assign a probability that matches the intention of the user to each of the functions. In this case, the candidate determination section 4 may appropriately extract the candidates by the number that can be presented by the candidate selection section 5 in descending order of the probabilities. In addition, the estimation section 3 may output the candidates to be presented directly to the candidate selection section 5. The candidate selection section 5 presents to the user, the candidates for the voice operation received from the candidate determination section 4 such that the user can select a target of the voice operation desired by the user. That is, the candidate selection section 5 functions as an entrance to the voice operation. Hereinbelow, the description will be given on the assumption that the candidate selection section 5 is a touch panel display. For example, in the case where the maximum number of candidates that can be displayed on the candidate selection section 5 is three, three candidates estimated by the estimation section 3 are displayed in descending order of the likelihoods. When the number of candidates estimated by the estimation section 3 is one, the one candidate is displayed on the candidate selection section 5. FIG. 3 is an example in which three candidates for the voice operation are displayed on the touch panel display. In FIG. 3(1), three candidates of “call”, “set a destination”, and “listen to music” are displayed and, in FIG. 3(2), three candidates of “have a meal”, “listen to music”, and “go to recreation park” are displayed. The three candidates are displayed in each of the examples of FIG. 3, but the number of displayed candidates, a display order thereof, and a layout thereof may be any number, any order, and any layout, respectively.

The user selects the candidate that the user desires to input by voice from among the displayed candidates. With regard to a selection method, the candidate displayed on the touch panel display may be appropriately touched and selected. When the candidate for the voice operation is selected by the user, the candidate selection section 5 transmits a selected coordinate position on the touch panel display to the candidate determination section 4, and the candidate determination section 4 associates the coordinate position with the candidate for the voice operation, and determines a target in which the voice operation is to be performed. Note that the determination of the target of the voice operation may be performed in the candidate selection section 5, and information on the selected candidate for the voice operation may be configured to be output directly to the guidance generation section 6. The determined target of the voice operation is accumulated as the history information together with the time information, position information and the like, and is used for future estimation of the candidate for the voice operation.

The guidance generation section 6 generates a guidance that requests the voice input to the user in accordance with the target of the voice operation determined in the candidate selection section 5. The guidance is preferably provided in a form of a question, and the user answers the question and the voice input is thereby allowed. When the guidance is generated, a guidance dictionary that stores a voice guidance, a display guidance, or a sound effect that is predetermined for each candidate for the voice operation displayed on the candidate selection section 5 is used. The guidance dictionary may be stored in the storage section in the user interface control device or may also be stored in the storage section of the server.

The guidance output section 7 outputs the guidance generated in the guidance generation section 6. The guidance output section 7 may be a speaker that outputs the guidance by voice or may also be a display section that outputs the guidance by using letters. Alternatively, the guidance may also be output by using both of the speaker and the display section. In the case where the guidance is output by using letters, the touch panel display that is the candidate selection section 5 may be used as the guidance output section 7. For example, as shown in FIG. 4(1), in the case where “call” is selected as the target of the voice operation, a guiding voice guidance of “who do you call?” is output, or a message “who do you call?” is displayed on a screen. The user performs the voice input to the guidance output from the guidance output section 7. For example, the user utters a surname “Yamada” to the guidance of “who do you call?”.

The voice recognition section 8 performs voice recognition of the content of utterance of the user to the guidance of the guidance output section 7. At this point, the voice recognition section 8 performs the voice recognition by using a voice recognition dictionary. The number of the voice recognition dictionaries may be one, or the dictionary may be switched according to the target of the voice operation determined in the candidate determination section 4. When the dictionary is switched or narrowed, a voice recognition rate is improved. In the case where the dictionary is switched or narrowed, information related to the target of the voice operation determined in the candidate determination section 4 is input not only to the guidance generation section 6 but also to the voice recognition section 8. The voice recognition dictionary may be stored in the storage section in the user interface control device or may also be stored in the storage section of the server.

The function determination section 9 determines the function corresponding to the voice input recognized in the voice recognition section 8, and transmits instruction information to the function execution section 10 to the effect that the function is executed. The function execution section 10 includes the equipment such as the car navigation device, audio, air conditioner, or telephone in the automobile, and the functions correspond to some functions to be executed by the pieces of equipment. For example, in the case where the voice recognition section 8 has recognized the user's voice input of “Yamada”, the function determination section 9 transmits the instruction information to a telephone set as one included in the function execution section 10 to the effect that a function “call Yamada” is executed. The executed function is accumulated as the history information together with the time information, position information and the like, and is used for the future estimation of the candidate for the voice operation.

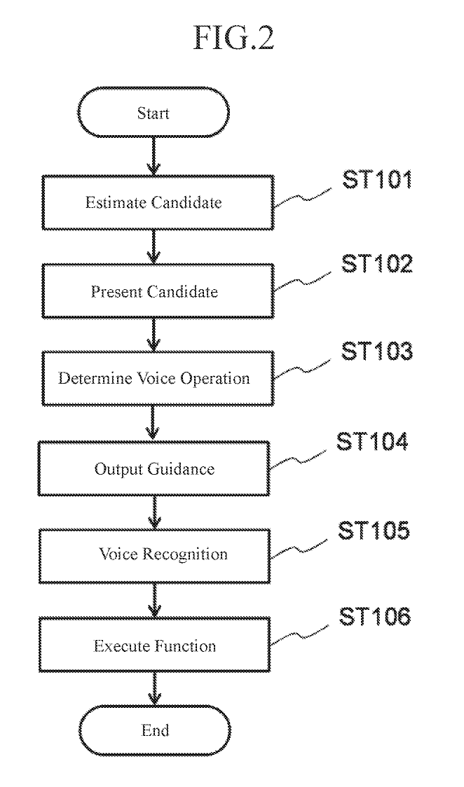

FIG. 2 is a flowchart for explaining an operation of the user interface system in Embodiment 1. In the flowchart, at least operations in ST101 and ST105 are operations of the user interface control device (i.e., processing procedures of a user interface control program). The operations of the user interface control device and the user interface system will be described with reference to FIG. 1 to FIG. 3.

The estimation section 3 estimates the candidate for the voice operation that the user will perform, that is, the voice operation that the user will desire to perform by using the information related to the current situation (the external environment information, operation history, and the like) (ST101). In the case where the user interface system is used as, for example, a vehicle-mounted device, the estimation operation may be started at the time an engine is started, and may be periodically performed, for example, every few seconds or may also be performed at a timing when the external environment is changed. Examples of the voice operation to be estimated include the following operations. In the case of a person who often makes a telephone call from a parking area of a company when he finishes his work and goes home, in a situation in which the current position is a “company parking area” and the current time is “night”, the voice operation of “call” is estimated. The estimation section 3 may estimate a plurality of candidates for the voice operation. For example, in the case of a person who often makes a telephone call, sets a destination, and listens to the radio when he goes home, the estimation section 3 estimates the functions of “call”, “set a destination”, and “listen to music” in descending order of the probabilities.

The candidate selection section 5 acquires information on the candidates for the voice operation to be presented from the candidate determination section 4 or the estimation section 3, and presents the candidates (ST102). Specifically, the candidates are displayed on, for example, the touch panel display. FIG. 3 includes examples each displaying three function candidates. FIG. 3(1) is a display example in the case where the functions of “call”, “set a destination”, and “listen to music” mentioned above are estimated. FIG. 3(2) is a display example in the case where the candidates for the voice operation of “have a meal”, “listen to music”, and “go to recreation park” are estimated in a situation of, for example, “holiday” and “11 AM”.

Next, the candidate determination section 4 or candidate selection section 5 determines what the candidate selected by the user from among the displayed candidates for the voice operation is, and determines the target of the voice operation (ST103).

Next, the guidance generation section 6 generates the guidance that requests the voice input to the user in accordance with the target of the voice operation determined by the candidate determination section 4. Subsequently, the guidance output section 7 outputs the guidance generated in the guidance generation section 6 (ST104). FIG. 4 shows examples of the guidance output. For example, as shown in FIG. 4(1), in the case where the voice operation of “call” is determined as the voice operation that the user will perform in ST103, the guidance of “who do you call?” by voice or by display is output. Alternatively, as shown in FIG. 4(2), in the case where the voice operation “set a destination” is determined, a guidance of “where do you go?” is output. Thus, since the target of the voice operation is selected specifically, the guidance output section 7 can provide the specific guidance to the user.

As shown in FIG. 4(1), the user inputs, for example, “Yamada” by voice in response to the guidance of “who do you call?”. As shown in FIG. 4(2), the user inputs, for example, “Tokyo station” by voice in response to the guidance of “where do you go?”. The content of the guidance is preferably a question in which a user's response to the guidance directly leads to execution of the function. The user is asked a specific question such as “who do you call?” or “where do you go?”, instead of a general guidance of “please talk when a bleep is heard”, and hence the user can easily understand what to say and the voice input related to the selected voice operation is facilitated.

The voice recognition section 8 performs the voice recognition by using the voice recognition dictionary (ST105). At this point, the voice recognition dictionary to be used may be switched to a dictionary related to the voice operation determined in ST103. For example, in the case where the voice operation of “call” is selected, the dictionary to be used may be switched to a dictionary in which words related to “telephone” such as the family name of a person and the name of a facility of which the telephone numbers are registered are stored.

The function determination section 9 determines the function corresponding to the recognized voice, and transmits an instruction signal to the function execution section 10 to the effect that the function is executed. Subsequently, the function execution section 10 executes the function based on the instruction information (ST106). For example, when the voice of “Yamada” is recognized in the example in FIG. 4(1), the function of “call Yamada” is determined, and Yamada registered in a telephone book is called with the telephone as one included in the function execution section 10. In addition, when a voice of “Tokyo station” is recognized in the example in FIG. 4(2), a function of “retrieve a route to Tokyo station” is determined, and a route retrieval to Tokyo station is performed by the car navigation device as one included in the function execution section 10. Note that the user may be notified of the execution of the function with “call Yamada” by voice or display when the function of calling Yamada is executed.

In the above description, it is assumed that the candidate selection section 5 is the touch panel display, and that the presentation section that notifies the user of the estimated candidate for the voice operation, and the input section that allows the user to select one candidate are integrated with each other. But the configuration of the candidate selection section 5 is not limited thereto. As described below, the presentation section that notifies the user of the estimated candidate for the voice operation, and the input section that allows the user to select one candidate may also be configured separately. For example, the candidate displayed on the display may be selected by a cursor operation with a joystick or the like. In this case, the display as the presentation section and the joystick as the input section and the like constitute the candidate selection section 5. In addition, a hard button corresponding to the candidate displayed on the display may be provided in a handle or the like, and the candidate may be selected by a push of the hard button. In this case, the display as the presentation section and the hard button as the input section constitute the candidate selection section 5. Further, the displayed candidate may also be selected by a gesture operation. In this case, a camera or the like that detects the gesture operation is included in the candidate selection section 5 as the input section. Furthermore, the estimated candidate for the voice operation may be output from a speaker by voice, and the candidate may be selected by the user through the button operation, joystick operation, or voice operation. In this case, the speaker as the presentation section and the hard button, the joystick, or a microphone as the input section constitute the candidate selection section 5. When the guidance output section 7 is the speaker, the speaker can also be used as the presentation section of the candidate selection section 5.

In the case where the user notices an erroneous operation after the candidate for the voice operation is selected, it is possible to re-select the candidate from among a plurality of the presented candidates. For example, an example in the case where three candidates shown in FIG. 4 are presented will be described. In the case where the user notices the erroneous operation after the function of “set a destination” is selected and the voice guidance of “where do you go?” is then output, it is possible to re-select “listen to music” from among the same three candidates. The guidance generation section 6 generates a guidance of “what do you listen to?” to the second selection. The user performs the voice operation about music playback in response to the guidance of “what do you listen to?” that is output from the guidance output section 7. The ability to re-select the candidate for the voice operation applies to the following embodiments.

As described above, according to the user interface system and the user interface control device in Embodiment 1, it is possible to provide the candidate for the voice operation that meets the intention of the user in accordance with the situation, that is, an entrance to the voice operation, so that an operational load of the user who performs the voice input is reduced. In addition, it is possible to prepare many candidates for the voice operation corresponding to subdivided purposes, and hence it is possible to cope with various purposes of the user widely.

### Embodiment 2

In Embodiment 1 described above, the example in which the function desired by the user is executed by the one voice input of the user to the guidance output from the guidance output section 7 has been described. In Embodiment 2, a description will be given of the user interface control device and the user interface system capable of execution of the function with a simple operation even in the case where the function to be executed cannot be determined by the one voice input of the user, like the case where a plurality of recognition results by the voice recognition section 8 are present or the case where a plurality of functions corresponding to the recognized voice are present, for example.

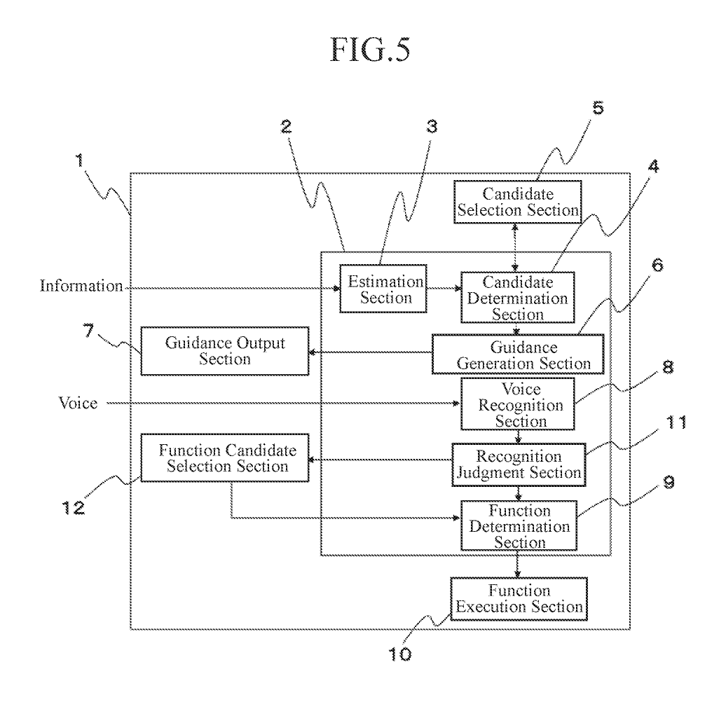

FIG. 5 is a view showing the user interface system in Embodiment 2 of the invention. The user interface control device 2 in Embodiment 2 has a recognition judgment section 11 that judges whether or not one function to be executed can be specified as the result of the voice recognition by the voice recognition section 8. In addition, the user interface system 1 in Embodiment 2 has a function candidate selection section 12 that presents a plurality of function candidates extracted as the result of the voice recognition to the user and causes the user to select the candidate. Hereinbelow, a description will be made on the assumption that the function candidate selection section 12 is the touch panel display. The other configurations are the same as those in Embodiment 1 shown in FIG. 1.

In the present embodiment, a point different from those in Embodiment 1 will be described. The recognition judgment section 11 judges whether or not the voice input recognized as the result of the voice recognition corresponds to one function executed by the function execution section 10, that is, whether or not a plurality of functions corresponding to the recognized voice input are present. For example, the recognition judgment section 11 judges whether the number of recognized voice inputs is one or more than one. In the case where the number of recognized voice inputs is one, the recognition judgment section 11 judges whether or not the number of functions corresponding to the voice input is one or more than one.

In the case where the number of recognized voice inputs is one and the number of functions corresponding to the voice input is one, the result of the recognition judgment is output to the function determination section 9, and the function determination section 9 determines the function corresponding to the recognized voice input. The operation in this case is the same as that in Embodiment 1.

On the other hand, in the case where a plurality of voice recognition results are present, the recognition judgment section 11 outputs the recognition results to the function candidate selection section 12. In addition, even when the number of the voice recognition results is one, in the case where a plurality of functions corresponding to the recognized voice input are present, the judgment result (candidate corresponding to the individual function) is transmitted to the function candidate selection section 12. The function candidate selection section 12 displays a plurality of candidates judged in the recognition judgment section 11. When the user selects one from among the displayed candidates, the selected candidate is transmitted to the function determination section 9. With regard to a selection method, the candidate displayed on the touch panel display may be touched and selected. In this case, the candidate selection section 5 has the function of an entrance to the voice operation that receives the voice input when the displayed candidate is touched by the user, while the function candidate selection section 12 has the function of a manual operation input section in which the touch operation of the user directly leads to the execution of the function. The function determination section 9 determines the function corresponding to the candidate selected by the user, and transmits instruction information to the function execution section 10 to the effect that the function is executed.

For example, as shown in FIG. 4(1), the case where the user inputs, for example, “Yamada” by voice in response to the guidance of “who do you call?” will be described. In the case where three candidates of, for example, “Yamada”, “Yamana”, and “Yamasa” are extracted as the recognition result of the voice recognition section 8, one function to be executed is not specified. Therefore, the recognition judgment section 11 transmits an instruction signal to the function candidate selection section 12 to the effect that the above three candidates are displayed on the function candidate selection section 12. Even when the voice recognition section 8 recognizes the voice input as “Yamada”, there are cases where a plurality of “Yamada”s, for example, “Yamada Taro”, “Yamada Kyoko”, and “Yamada Atsushi” are registered in the telephone book, so that they cannot be narrowed down to one. In other words, these cases include the case where a plurality of functions “call Yamada Taro”, “call Yamada Kyoko”, and “call Yamada Atsushi” are present as the functions corresponding to “Yamada”. In this case, the recognition judgment section 11 transmits the instruction signal to the function candidate selection section 12 to the effect that candidates “Yamada Taro”, “Yamada Kyoko”, and “Yamada Atsushi” are displayed on the function candidate selection section 12.

When one candidate is selected from among the plurality of candidates displayed on the function candidate selection section 12 by the user's manual operation, the function determination section 9 determines the function corresponding to the selected candidate, and instructs the function execution section 10 to execute the function. Note that the determination of the function to be executed may be performed in the function candidate selection section 12, and the instruction information may be output directly to the function execution section 10 from the function candidate selection section 12. For example, when “Yamada Taro” is selected, Yamada Taro is called.

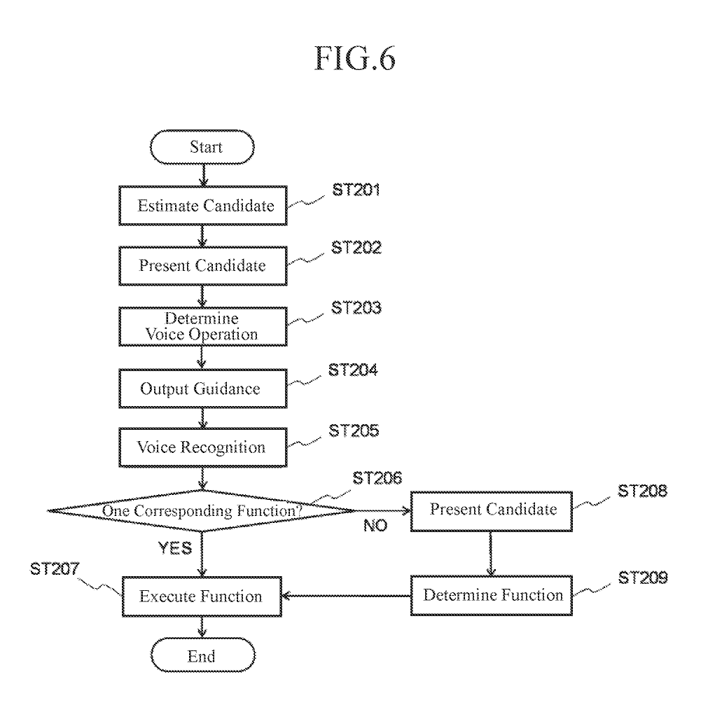

FIG. 6 is a flowchart of the user interface system in Embodiment 2. In the flowchart, at least operations in ST201, ST205, and ST206 are operations of the user interface control device (i.e., processing procedures of a user interface control program). In FIG. 6, ST201 to ST204 are the same as ST101 to ST104 in FIG. 2 explaining Embodiment 1, and hence descriptions thereof will be omitted.

In ST205, the voice recognition section 8 performs the voice recognition by using the voice recognition dictionary. The recognition judgment section 11 judges whether or not the recognized voice input corresponds to one function executed by the function execution section 10 (ST206). In the case where the number of the recognized voice inputs is one and the number of the functions corresponding to the voice input is one, the recognition judgment section 11 transmits the result of the recognition judgment to the function determination section 9, and the function determination section 9 determines the function corresponding to the recognized voice input. The function execution section 10 executes the function based on the function determined in the function determination section 9 (ST207).

In the case where the recognition judgment section 11 judges that a plurality of the recognition results of the voice input in the voice recognition section 8 are present, or judges that a plurality of the functions corresponding to one recognized voice input are present, the candidates corresponding to the plurality of functions are presented by the function candidate selection section 12 (ST208). Specifically, the candidates are displayed on the touch panel display. When one candidate is selected from among the candidates displayed on the function candidate selection section 12 by the user's manual operation, the function determination section 9 determines the function to be executed (ST209), and the function execution section 10 executes the function based on the instruction from the function determination section 9 (ST207). Note that, as described above, the determination of the function to be executed may be performed in the function candidate selection section 12, and the instruction information may be output directly to the function execution section 10 from the function candidate selection section 12. When the voice operation and the manual operation are used in combination, it is possible to execute the target function more quickly and reliably than in the case where the interaction between the user and the equipment only by voice is repeated.

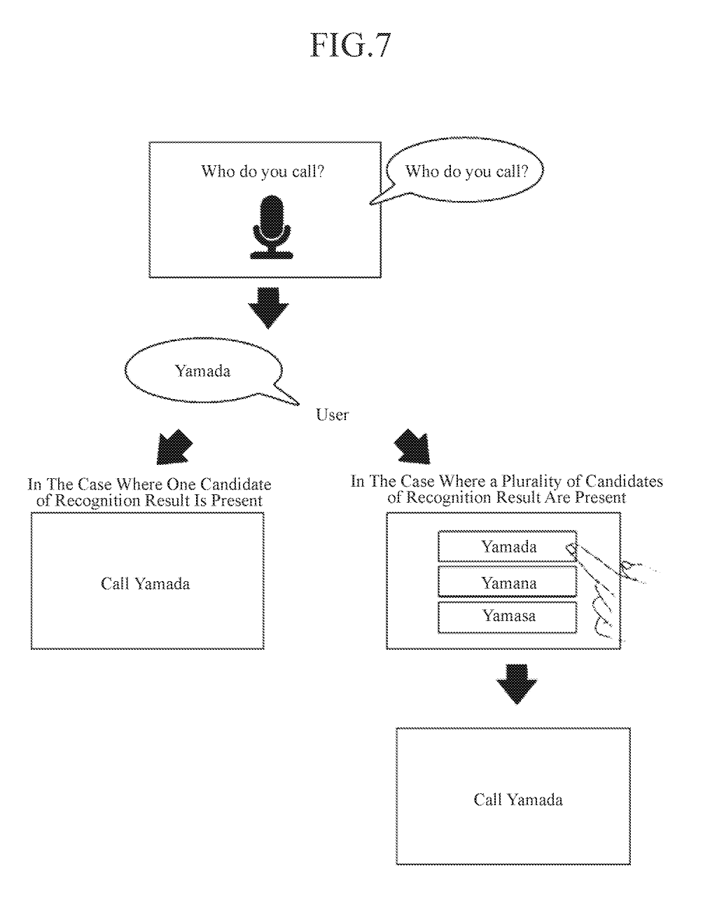

For example, as shown in FIG. 7, in the case where the user inputs “Yamada” by voice in response to the guidance of “who do you call?”, when one function can be determined as the result of the voice recognition, the function of “call Yamada” is executed, and the display or the voice of “call Yamada” is output. In addition, in the case where three candidates of “Yamada”, “Yamana”, and “Yamada” are extracted as the result of the voice recognition, the three candidates are displayed. When the user selects “Yamada”, the function of “call Yamada” is executed, and the display or the voice of “call Yamada” is output.

In the above description, it is assumed that the function candidate selection section 12 is the touch panel display, and that the presentation section that notifies the user of the candidate for the function and the input section for the user to select one candidate are integrated with each other. But the configuration of the function candidate selection section 12 is not limited thereto. Similarly to the candidate selection section 5, the presentation section that notifies the user of the candidate for the function, and the input section that allows the user to select one candidate may be configured separately. For example, the presentation section is not limited to the display and may be the speaker, and the input section may be a joystick, hard button, or microphone.

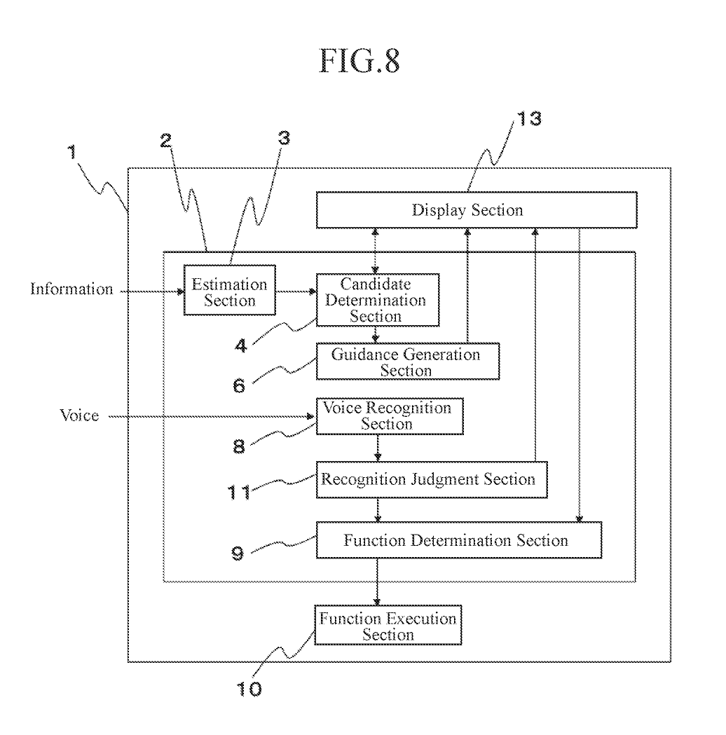

In addition, in the above description with reference to FIG. 5, the candidate selection section 5 as the entrance to the voice operation, the guidance output section 7, and the function candidate selection section 12 for finally selecting the function that the user desires to execute are provided separately, but they may be provided in one display section (touch panel display). FIG. 8 is a configuration diagram in the case where one display section 13 has the role of the entrance to the voice operation, the role of the guidance output, and the role of the manual operation input section for finally selecting the function. That is, the display section 13 corresponds to the candidate selection section, the guidance output section, and a function candidate output section. In the case where the one display section 13 is used, usability for the user is improved by indicating which kind of operation target the displayed item corresponds to. For example, in the case where the display section functions as the entrance to the voice operation, an icon of the microphone is displayed before the displayed item. The display of the three candidates in FIG. 3 and FIG. 4 is a display example in the case where the display section functions as the entrance to the voice operation. In addition, the display of three candidates in FIG. 7 is a display example for a manual operation input without the icon of the microphone.

Further, the guidance output section may be the speaker, and the candidate selection section 5 and the function candidate selection section 12 may be configured by one display section (touch panel display). Furthermore, the candidate selection section 5 and the function candidate selection section 12 may be configured by one presentation section and one input section. In this case, the candidate for the voice operation and the candidate for the function to be executed are presented by the one presentation section, and the user selects the candidate for the voice operation and selects the function to be executed by using the one input section.

In addition, the function candidate selection section 12 is configured such that the candidate for the function is selected by the user's manual operation, but it may also be configured such that the function desired by the user may be selected by the voice operation from among the displayed candidates for the function or the candidates for the function output by voice. For example, in the case where the candidates for the function of “Yamada Taro”, “Yamada Kyoko”, and “Yamada Atsushi” are presented, it may be configured that “Yamada Taro” is selected by an input of “Yamada Taro” by voice, or that when the candidates are respectively associated with numbers such as “1”, “2”, and “3”, “Yamada Taro” is selected by an input of “1” by voice.

As described above, according to the user interface system and the user interface control device in Embodiment 2, even in the case where the target function cannot be specified by the one voice input, since it is configured that the user can make a selection from among the presented candidates for the function, it is possible to execute the target function with the simple operation.

### Embodiment 3

When a keyword uttered by a user is a keyword having a broad meaning, there are cases where the function cannot be specified to be not executable, or many function candidates are presented, so that it takes time to select the candidate. For example, in the case where the user utters “amusement park” in response to a question of “where do you go?”, since a large number of facilities belong to “amusement park”, it is not possible to specify the amusement park. In addition, when a large number of facility names of the amusement park are displayed as candidates, it takes time for the user to make a selection. Therefore, a feature of the present embodiment is as follows: in the case where the keyword uttered by the user is a word having a broad meaning, a candidate for a voice operation that the user will desire to perform is estimated by the use of an intention estimation technique, the estimated result is specifically presented as the candidate for the voice operation, that is, an entrance to the voice operation, and execution of a target function is configured to be allowed at the next utterance.

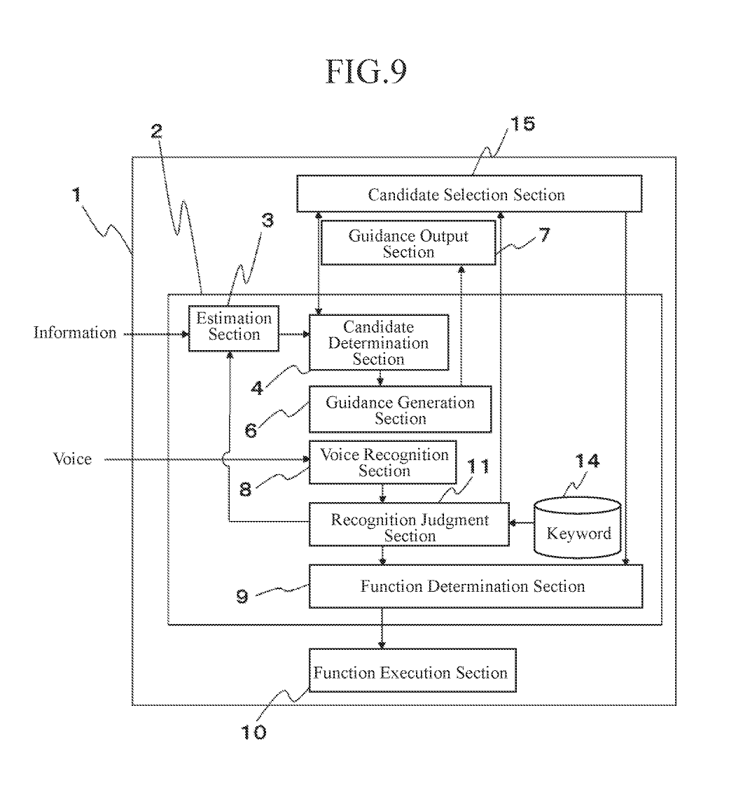

In the present embodiment, a point different from those in Embodiment 2 described above will be mainly described. FIG. 9 is a configuration diagram of a user interface system in Embodiment 3. A main difference from Embodiment 2 described above is that the recognition judgment section 11 uses keyword knowledge 14, and that the estimation section 3 is used again in accordance with the result of the judgment of the recognition judgment section 11 to thereby estimate the candidate for the voice operation. Hereinbelow, a description will be made on the assumption that a candidate selection section 15 is the touch panel display.

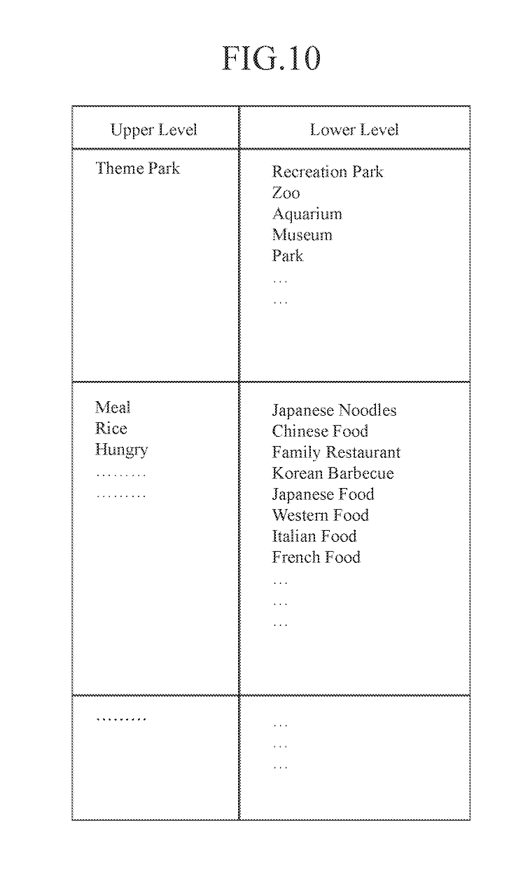

The recognition judgment section 11 judges whether the keyword recognized in the voice recognition section 8 is a keyword of an upper level or a keyword of a lower level by using the keyword knowledge 14. In the keyword knowledge 14, for example, words as in a table in FIG. 10 are stored. For example, as the keyword of the upper level, there is “theme park” and, as the keyword of the lower level of theme park, “recreation park”, “zoo”, and “aquarium” are associated therewith. In addition, as the keywords of the upper level, there are “meal”, “rice”, and “hungry” and, as the keywords of the lower level of them, “noodle”, “Chinese food”, “family restaurant” and the like are associated therewith.

For example, in the case where the recognition judgment section 11 recognizes the first voice input as “theme park”, since “theme park” is the word of the upper level, words such as “recreation park”, “zoo”, “aquarium”, and “museum” as the keywords of the lower level corresponding to “theme park” are sent to the estimation section 3. The estimation section 3 estimates the word corresponding to the function that the user will desire to execute from among the words such as “recreation park”, “zoo”, “aquarium”, and “museum” received from the recognition judgment section 11 by using external environment information and history information. The candidate for the word obtained by the estimation is displayed on the candidate selection section 15.

On the other hand, in the case where the recognition judgment section 11 judges that the keyword recognized in the voice recognition section 8 is a word of the lower level leading to the final execution function, the word is sent to the function determination section 9, and the function corresponding to the word is executed by the function execution section 10.

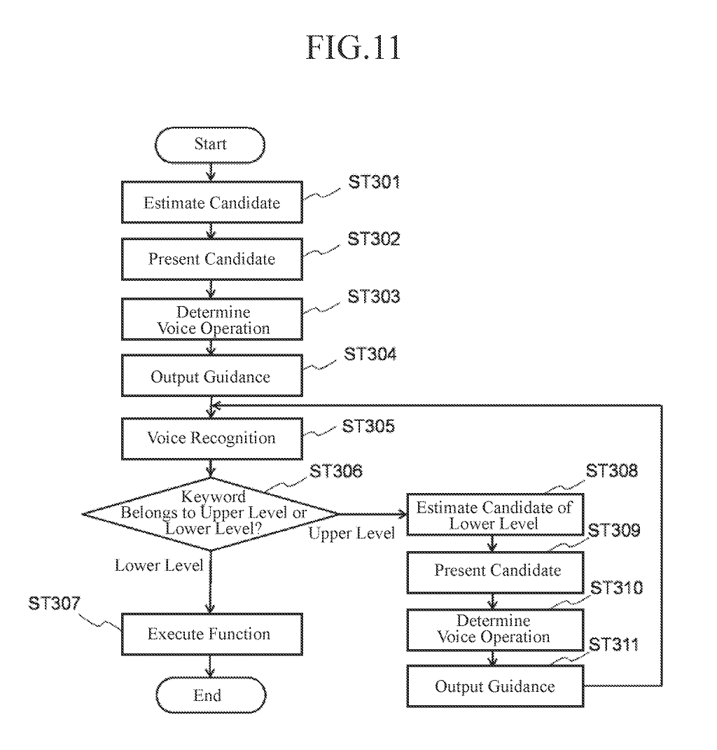

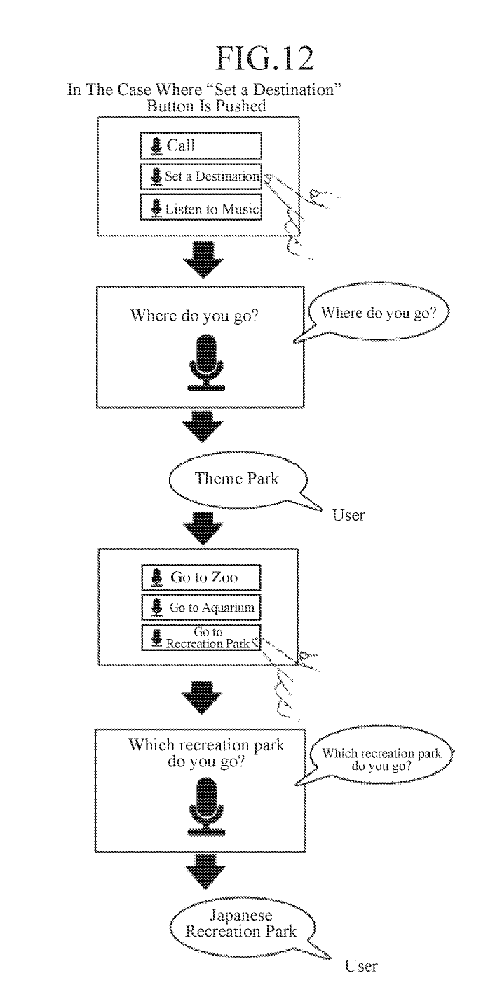

FIG. 11 is a flowchart showing the operation of the user interface system in Embodiment 3. In the flowchart, at least operations in ST301, ST305, ST306, and ST308 are operations of the user interface control device (i.e., processing procedures of a user interface control program). Operations in ST301 to ST304 in which the voice operation that the user will desire to perform, that is, the voice operation that meets the intention of the user, is estimated in accordance with the situation, the estimated candidate for the voice operation is presented, and the guidance output related to the voice operation selected by the user is performed are the same as those in Embodiments 1 and 2 described above. FIG. 12 is a view showing a display example in Embodiment 3. Hereinbelow, operations in and after ST305 that are different from those in Embodiments 1 and 2, that is, operations after the operation in which the utterance of the user to the guidance output is voice recognized, will be mainly described with reference to FIG. 9 to FIG. 12.

First, as shown in FIG. 12, it is assumed that there are three candidates for the voice operation that are estimated in ST301 and displayed on the candidate selection section 15 in ST302, with the candidates being “call”, “set a destination”, and “listen to music”. When the user selects “set a destination”, the target of the voice operation is determined (ST303), and the guidance output section 7 asks the user the question of “where do you go?” by voice (ST304). When the user inputs “theme park” by voice in response to the guidance, the voice recognition section 8 performs the voice recognition (ST305). The recognition judgment section 11 receives the recognition result from the voice recognition section 8, and judges whether the recognition result is the keyword of the upper level or the keyword of the lower level by referring to the keyword knowledge 14 (ST306). In the case where it is judged that the recognition result is the keyword of the upper level, the flow proceeds to ST308. On the other hand, in the case where it is judged that the recognition result is the keyword of the lower level, the flow proceeds to ST307.

For example, it is assumed that the voice recognition section 8 has recognized the voice as “theme park”. As shown in FIG. 10, since “theme park” is the keyword of the upper level, the recognition judgment section 11 sends the keywords of the lower level corresponding to “theme park” such as “recreation park”, “zoo”, “aquarium”, and “museum” to the estimation section 3. The estimation section 3 estimates the candidate for the voice operation that the user may desire to perform from among a plurality of the keywords of the lower level received from the recognition judgment section 11 such as “recreation park”, “zoo”, “aquarium”, and “museum” by using the external environment information and history information (ST308). Note that either one of the external environment information and the history information may also be used.

The candidate selection section 15 presents the estimated candidate for the voice operation (ST309). For example, as shown in FIG. 12, three items of “go to zoo”, “go to aquarium”, and “go to recreation park” are displayed as the entrances to the voice operation. The candidate determination section 4 determines the target to be subjected to the voice operation from among the presented voice operation candidates based on the selection by the user (ST310). Note that the determination of the target of the voice operation may be performed in the candidate selection section 15, and information on the selected voice operation candidate may be output directly to the guidance generation section 6. Next, the guidance generation section 6 generates the guidance corresponding to the determined target of the voice operation, and the guidance output section 7 outputs the guidance. For example, in the case where it is judged that the user has selected “go to recreation park” from among the items presented to the user, a guidance of “which recreation park do you go” is output by voice (ST311). The voice recognition section 8 recognizes the utterance of the user to the guidance (ST305). Thus, it is possible to narrow the candidate by re-estimating the candidate for the voice operation that meets the intention of the user, and ask the user what he desires to do more specifically, and hence the user can easily perform the voice input, and execute the target function without performing the voice input repeatedly.

When the recognition result of the voice recognition section 8 is the executable keyword of the lower level, the function corresponding to the keyword is executed (ST307). For example, in the case where the user has uttered “Japanese recreation park” in response to the guidance of “which recreation park do you go?”, the function of, for example, retrieving a route to “Japanese recreation park” is executed by the car navigation device as the function execution section 10.

The target of the voice operation determined by the candidate determination section 4 in ST309 and the function executed by the function execution section 10 in ST307 are accumulated in a database (not shown) as the history information together with time information, position information and the like, and are used for future estimation of the candidate for the voice operation.

Although omitted in the flowchart in FIG. 11, in the case where the recognition judgment section 11 judges that the keyword recognized in the voice recognition section 8 is the word of the lower level, but does not lead to the final execution function, similarly to Embodiment 2 described above, the candidate for the function for the selection of the final execution function by the user may be displayed on the candidate selection section 15, and the function may be appropriately determined by the selection by the user (ST208 and ST209 in FIG. 6). For example, in the case where a plurality of recreation parks having names similar to “Japanese recreation park” are present and cannot be narrowed down to one by the voice recognition section 8, or in the case where it is judged that a plurality of functions corresponding to one recognized candidate of, for example, retrieval of the route and retrieval of the parking area are present, the candidate leading to the final function is displayed on the candidate selection section 15. Then, when the candidate for one function is selected by the operation of the user, the function to be executed is determined.

In FIG. 9, the configuration is given in which the selection of the voice operation candidate and the selection of the candidate for the function are performed by one candidate selection section 15, but a configuration may also be given in which, as shown in FIG. 5, the candidate selection section 5 for selecting the voice operation candidate and the function candidate selection section 12 for selecting the candidate for the function after the voice input are provided separately. In addition, as in FIG. 8, one display section 13 may have the role of the entrance to the voice operation, the role of the manual operation input section, and the role of the guidance output.

In addition, in the above description, it is assumed that the candidate selection section 15 is the touch panel display, and that the presentation section that notifies the user of the estimated candidate for the voice operation and the input section for the user to select one candidate are integrated with each other, but the configuration of the candidate selection section 15 is not limited thereto. As described in Embodiment 1, the presentation section that notifies the user of the estimated candidate for the voice operation and the input section for the user to select one candidate may be configured separately. For example, the presentation section is not limited to the display but may also be the speaker, and the input section may also be a joystick, hard button, or microphone.

In addition, in the above description, it is assumed that the keyword knowledge 14 is stored in the user interface control device, but may also be stored in the storage section of the server.

As described above, according to the user interface system and the user interface control device in Embodiment 3, even when the keyword input by the user by voice is the keyword having a broad meaning, when the candidate for the voice operation that meets the intention of the user is re-estimated to thus narrow the candidate, and the narrowed candidate is presented to the user, it is possible to reduce the operational load of the user who performs the voice input.

### Embodiment 4

In each Embodiment described above, it is configured that the candidates for the voice operation estimated by the estimation section 3 are presented to the user. However, in the case where a likelihood of each of the candidates for the voice operation estimated by the estimation section 3 is low, the candidates each having a low probability that matches the intention of the user are to be presented. Therefore, in Embodiment 4, in the case where the likelihood of each of the candidates determined by the estimation section 3 is low, it is adapted that the candidates are presented with converted to a superordinate concept.

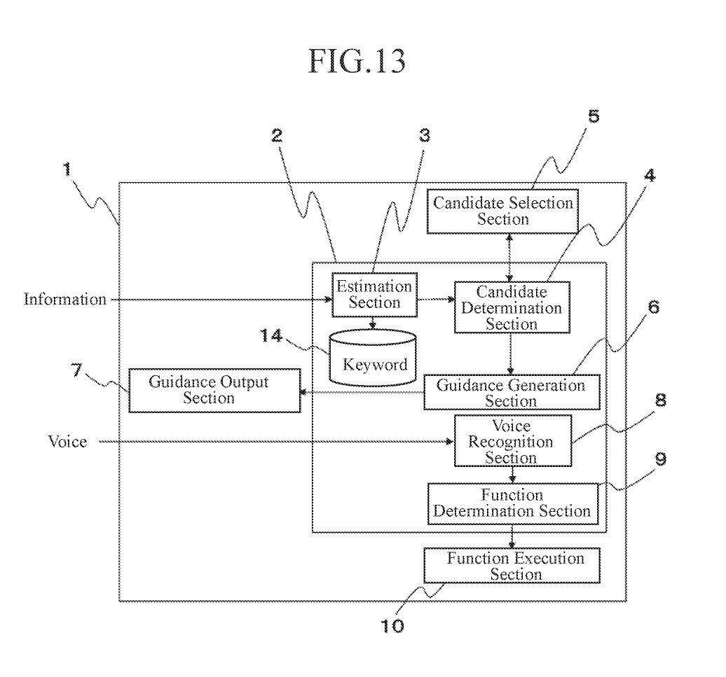

In the present embodiment, a point different from those in Embodiment 1 described above will be mainly described. FIG. 13 is a configuration diagram of the user interface system in Embodiment 4. A difference from Embodiment 1 described above is that the estimation section 3 uses the keyword knowledge 14. The other configurations are the same as those in Embodiment 1. The keyword knowledge 14 is the same as the keyword knowledge 14 in Embodiment 3 described above. Note that, as shown in FIG. 1, the following description will be made on the assumption that the estimation section 3 in Embodiment 1 uses the keyword knowledge 14, but a configuration may be given in which the estimation section 3 in each of Embodiments 2 and 3 (the estimation section 3 in each of FIGS. 5, 8, and 9) may use the keyword knowledge 14.

The estimation section 3 receives the information related to the current situation such as the external environment information and history information, and estimates the candidate for the voice operation that the user will perform at the present time. In the case where the likelihood of each of the candidates extracted by the estimation is low, when a likelihood of a candidate for a voice operation of an upper level for them is high, the estimation section 3 transmits the candidate for the voice operation of the upper level to the candidate determination section 4.

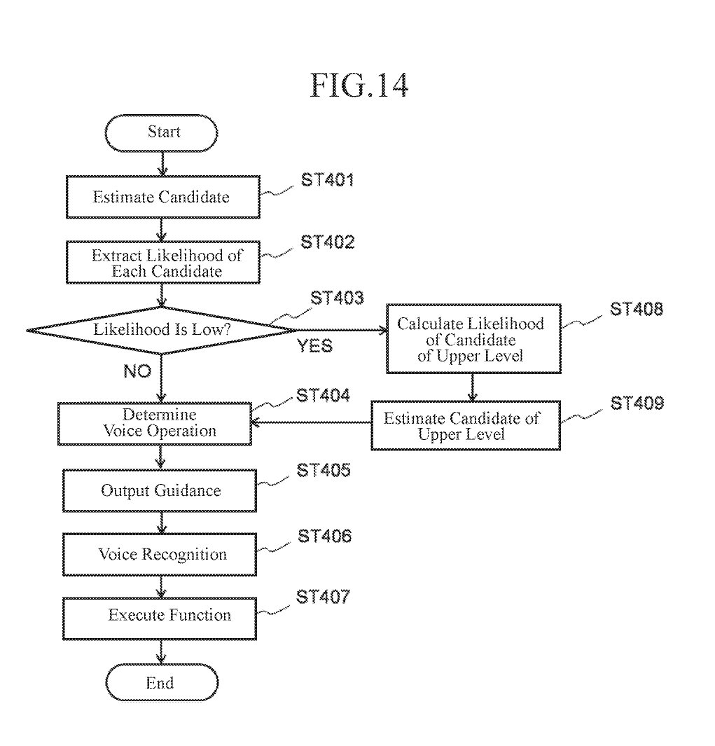

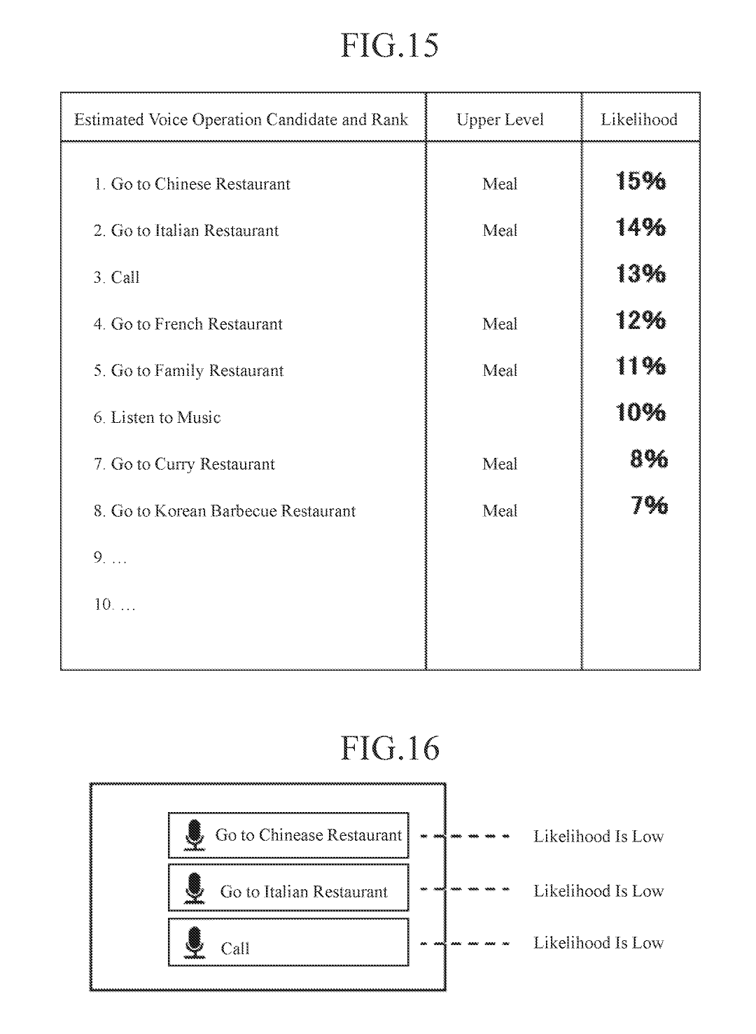

FIG. 14 is a flowchart of the user interface system in Embodiment 4. In the flowchart, at least operations in ST401 to ST403, ST406, ST408, and ST409 are operations of the user interface control device (i.e., processing procedures of a user interface control program). In addition, each of FIG. 15 to FIG. 18 is an example of the estimated candidate for the voice operation. The operations in Embodiment 4 will be described with reference to FIG. 13 to FIG. 18 and FIG. 10 that shows the keyword knowledge 14.

The estimation section 3 estimates the candidate for the voice operation that the user will perform by using the information related to the current situation (the external environment information, history information and the like) (ST401). Next, the estimation section 3 extracts the likelihood of each or the estimated candidate (ST402). When the likelihood of each candidate is high, the flow proceeds to ST404, the candidate determination section 4 determines what the candidate selected by the user is, from among the candidates for the voice operation presented in the candidate selection section 5, and determines the target of the voice operation. Additionally, the determination of the target of the voice operation may be performed in the candidate selection section 5, and information on the selected candidate for the voice operation may be output directly to the guidance generation section 6. The guidance output section 7 outputs the guidance that requests the voice input to the user in accordance with the determined target of the voice operation (ST405). The voice recognition section 8 recognizes the voice input by the user in response to the guidance (ST406), and the function execution section 10 executes the function corresponding to the recognized voice (ST407).

On the other hand, in the case where the estimation section 3 determines that the likelihood of each estimated candidate is low in ST403, the flow proceeds to ST408. An example of such a case includes the case where candidates shown in FIG. 15 are determined as the result of the estimation. FIG. 15 is a table in which the individual candidates are arranged in descending order of the likelihoods. The likelihood of a candidate of “go to Chinese restaurant” is 15%, the likelihood of a candidate of “go to Italian restaurant” is 14%, and the likelihood of the candidate “call” is 13%, so that the likelihood of each candidate is low, and hence, as shown in FIG. 16, for example, even when the candidates are displayed in descending order of the likelihoods, the probability that the candidate matches a target to be voice operated by the user is low.

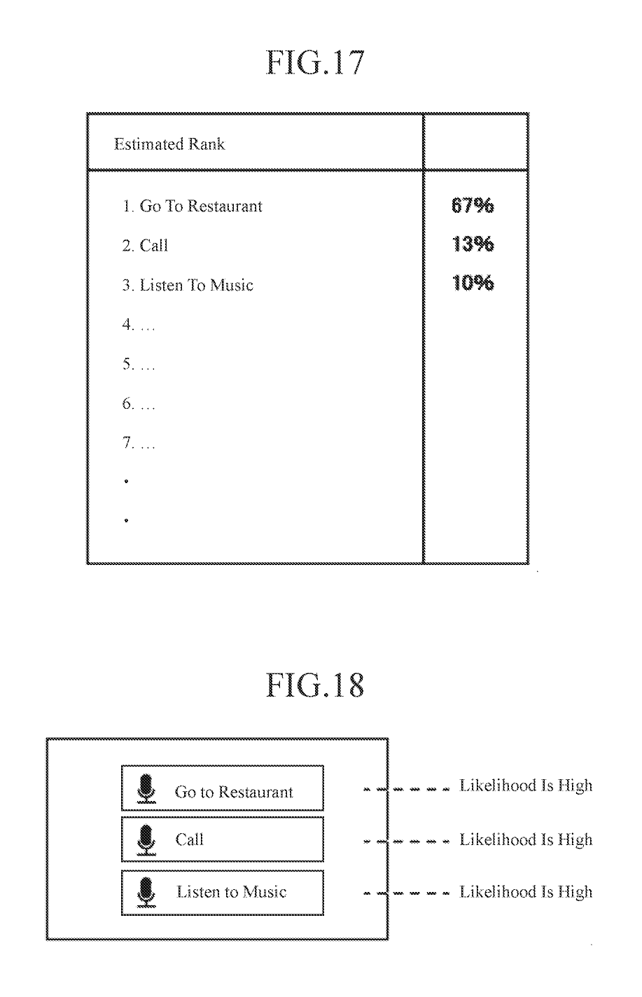

Therefore, in Embodiment 4, the likelihood of the voice operation of the upper level of each estimated candidate is calculated. With regard to a calculation method, for example, the likelihoods of the candidates of the lower level that belong to the same voice operation of the upper level are added together. For example, as shown in FIG. 10, the upper level of the candidates of “Chinese food”, “Italian food”, “French food”, “family restaurant”, “curry”, and “Korean barbecue” is “meal”; when the likelihoods of the candidates of the lower level are added together, the likelihood of “meal” as the candidate for the voice operation of the upper level is 67%. Based on the calculation result, the estimation section 3 estimates the candidate including the voice operation of the upper level (ST409). In the above example, as shown in FIG. 17, the estimation section 3 estimates “go to restaurant” (likelihood 67%), “call” (likelihood 13%), and “listen to music” (10%) in descending order of the likelihoods. The estimation result is displayed on the candidate selection section 5 as shown in FIG. 18, for example, and the target of the voice operation is determined by the candidate determination section 4 or the candidate selection section 5 based on the selection by the user (ST404). Operations in and after ST405 are the same as those in the case where the likelihood of each candidate described above is high, and hence descriptions thereof will be omitted.

Note that, in the above description, it is assumed that the keyword knowledge 14 is stored in the user interface control device, but may also be stored in the storage section of the server.

As described above, according to the user interface system and the user interface control device in Embodiment 4, the candidate for the voice operation of the superordinate concept having a high probability that matches the intention of the user is presented, and hence it is possible to perform the voice input more reliably.

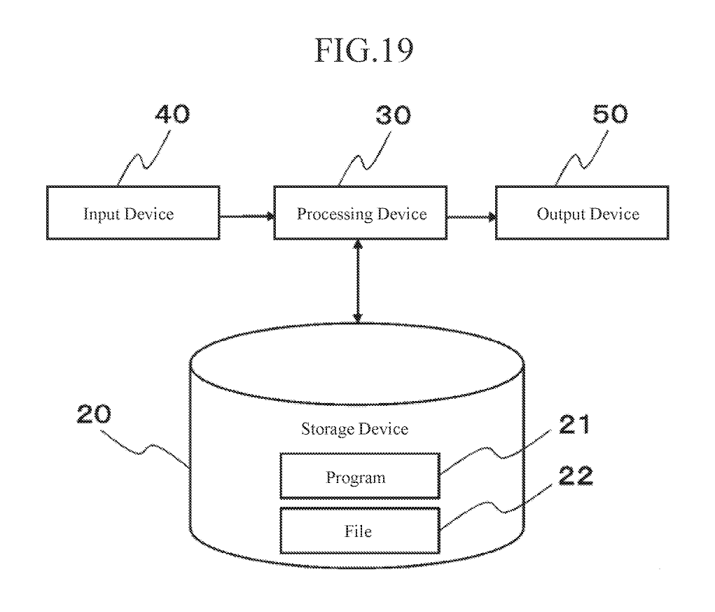

FIG. 19 is a view showing an example of a hardware configuration of the user interface control device 2 in each of Embodiments 1 to 4. The user interface control device 2 is a computer, and includes hardware such as a storage device 20, a processing device 30, an input device 40, and an output device 50. The hardware is used by the individual sections (the estimation section 3, candidate determination section 4, the guidance generation section 6, voice recognition section 8, function determination section 9, and recognition judgment section 11) of the user interface control device 2.

The storage device 20 is, for example, a ROM (Read Only Memory), a RAM (Random Access Memory), or an HDD (Hard Disk Drive). The storage section of the server and the storage section of the user interface control device 2 can be mounted through the storage device 20. In the storage device 20, a program 21 and a file 22 are stored. The program 21 includes programs that execute processing of the individual sections. The file 22 includes data, information, signals and the like of which the input, output, operations and the like are performed by the individual sections. In addition, the keyword knowledge 14 is included in the file 22. Further, the history information, guidance dictionary, or voice recognition dictionary may be included in the file 22.

The processing device 30 is, for example, a CPU (Central Processing Unit). The processing device 30 reads the program 21 from the storage device 20, and executes the program 21. The operations of the individual sections of the user interface control device 2 can be implemented by the processing device 30.

The input device 40 is used for inputs (receptions) of data, information, signals and the like by the individual sections of the user interface control device 2. In addition, the output device 50 is used for outputs (transmissions) of the data, information, signals and the like by the individual sections of the user interface control device 2.

### REFERENCE SIGNS LIST

1: user interface system
2: user interface control device
3: estimation section
4: candidate determination section
5: candidate selection section
6: guidance generation section
7: guidance output section
8: voice recognition section
9: function determination section
10: function execution section
11: recognition judgment section
12: function candidate selection section
13: display section
14: keyword knowledge
15: candidate selection section
20: storage device
21: program
22: file
30: processing device
40: input device
50: output device

1-10. (canceled)

11. A user interface system comprising:
an estimator that estimates a voice operation intended by a user, based on information related to a current situation;
a candidate selector that allows the user to select one candidate from among a plurality of candidates for the voice operation estimated by the estimator;
a guidance output processor that outputs a guidance to request a voice input of the user concerning the candidate selected by the user; and
a function executor that executes a function corresponding to the voice input by the user to the guidance, wherein
the estimator outputs, in a case where likelihoods of the plurality of candidates for the estimated voice operation are low, a candidate for the voice operation of a superordinate concept of the plurality of candidates to the candidate selector as an estimation result, and
the candidate selector presents the candidate for the voice operation of the superordinate concept.

12. The user interface system according to claim 11, wherein
in a case where a plurality of candidates for the function corresponding to the voice input of the user exist, the plurality of candidates for the function are presented such that one candidate for the function is selected by the user.

13. The user interface system according to claim 11, wherein
the estimator estimates, in a case where the voice input of the user is a word of a superordinate concept, a candidate for the voice operation of a subordinate concept included in the word of the superordinate concept, based on the information related to the current situation, and
the candidate selector presents the candidate for the voice operation of the subordinate concept estimated by the estimator.

14. A user interface control device comprising:
an estimator that estimates a voice operation intended by a user, based on information related to a current situation;
a guidance generator that generates a guidance to request a voice input of the user concerning one candidate that is determined based on a selection by the user from among a plurality of candidates for the voice operation estimated by the estimator;
a voice recognizer that recognizes the voice input of the user to the guidance; and
a function determinator that outputs instruction information such that a function corresponding to the recognized voice input is executed, wherein
the estimator outputs, in a case where likelihoods of the plurality of candidates for the estimated voice operation are low, a candidate for the voice operation of a superordinate concept of the plurality of candidates as an estimation result, and
the guidance generator generates the guidance to request the voice input of the user concerning the estimated candidate for the voice operation of the superordinate concept.

15. The user interface control device according to claim 14, further comprising a recognition judgment processor that judges whether or not a plurality of candidates for the function corresponding to the voice input of the user that is recognized by the voice recognizer exist and, in a case where the recognition judgment processor judges that the plurality of candidates for the function exist, outputs a result of the judgment such that the plurality of candidates for the function are presented to the user.

16. The user interface control device according to claim 14, wherein
the voice recognizer determines whether the voice input of the user is a word of a superordinate concept or a word of a subordinate concept,
the estimator estimates, in a case where the voice input of the user is the word of the superordinate concept, a candidate for the voice operation of the subordinate concept included in the word of the superordinate concept, based on the information related to the current situation, and
the guidance generator generates the guidance concerning one candidate that is determined based on the selection by the user from the candidate for the voice operation of the subordinate concept.

17. A user interface control method comprising the steps of:
estimating a voice operation intended by a user, based on information related to a current situation;
generating a guidance to request a voice input of the user concerning one candidate that is determined based on a selection by the user from among a plurality of candidates for the voice operation estimated in the estimating step;
recognizing the voice input of the user to the guidance;
outputting instruction information such that a function corresponding to the recognized voice input is executed;
outputting, in a case where likelihoods of the plurality of candidates for the voice operation estimated in the estimating step are low, a candidate for the voice operation of a superordinate concept of the plurality of candidates to the candidate selector as an estimation result; and
presenting the candidate for the voice operation of the superordinate concept.

18. A user interface control program causing a computer to execute:
estimation processing that estimates voice operation intended by a user, based on information related to a current situation;
guidance generation processing that generates a guidance to request a voice input of the user concerning one candidate that is determined based on a selection by the user from among a plurality of candidates for the voice operation estimated by the estimation processing;
voice recognition processing that recognizes the voice input of the user to the guidance;
processing that outputs instruction information such that a function corresponding to the recognized voice input is executed;
processing that outputs, in a case where likelihoods of the plurality of candidates for the voice operation estimated in the estimating step are low, a candidate for the voice operation of a superordinate concept of the plurality of candidates to the candidate selector as an estimation result; and
processing that presents the candidate for the voice operation of the superordinate concept.
